(19) United States
(12) Patent Application Publication
(10) Pub. No.: US 2012/0067844 A1
(43) Pub. Date: Mar. 22, 2012

(54) METHOD OF MANUFACTURING RECORDING MEDIUM

(76) Inventors: Yoshiyuki Kamata, Tokyo (JP); Kaori Kimura, Yokohama-shi (JP); Takeshi Iwasaki, Inagi-shi (JP)

(21) Appl. No.: 13/185,822

(22) Filed: Jul. 19, 2011

(30) Foreign Application Priority Data
Sep. 17, 2010 (JP) 2010-209980

(51) Int. Cl. G11B 5/84; G11B 5/851

(52) U.S. Cl. 216/22; 427/569

(57) ABSTRACT

According to one embodiment, in a method manufacturing a magnetic recording medium which is configured such that a ferromagnetic recording part is formed on a substrate in a desired track pattern or a desired bit pattern, a ferromagnetic film is formed on a substrate, and then a B thin film is formed on a region for isolating the ferromagnetic film between tracks or bits. Subsequently, ions are radiated on the B thin film, thereby increasing a B content of the region of the ferromagnetic film, on which the B thin film has been formed, and nonmagnetizing the region.

### CROSS-REFERENCE TO RELATED APPLICATIONS

This application is based upon and claims the benefit of priority from Japanese Patent Application No. 2010-209980, filed Sep. 17, 2010; the entire contents of which are incorporated herein by reference.

### FIELD

Embodiments described herein relate generally to a method of manufacturing a magnetic recording medium.

### BACKGROUND

In recent years, attention has been paid to, as high-density magnetic recording media, discrete track recording patterned media (DTR media) in which recording tracks are physically isolated, and bit patterned media (RPM) in which recording bits are physically isolated also in a down-track direction (disk circumferential direction).

Since this type of patterned media constitutes a magnetic recording apparatus (HDD) by being combined with a recording head which levitates with a levitation amount of 10 nm or less, the surface planarity of the patterned media is important. In order to stably levitate the recording head, the surface asperities of the patterned media should be, notably, 10 nm or less. Thus, the surface is generally planarized by burying a nonmagnetic material in gaps between physically discrete recording tracks or recording bits.

However, the addition of fabrication steps, such as burying a nonmagnetic material and planarization, leads to process damage, and degradation in productivity and an increase in cost due to the increase in number of steps.

### BRIEF DESCRIPTION OF THE DRAWINGS

FIGS. 1A, 1B, 1C, 1D and 1E are cross-sectional views illustrating fabrication steps of a stamper for UV imprint, which is used in a first embodiment.

FIG. 2 is a plan view showing a sector pattern of DTR media.

FIG. 3 is a plan view showing a sector pattern of BPM.

FIGS. 4A, 4B, 4C, 4D, 4E, 4F, 4G, 4H and 4I are cross-sectional views illustrating fabrication steps of a patterned medium according to the first embodiment.

FIGS. 5A and 55 are cross-sectional views showing the structure of the patterned medium of the first embodiment in comparison with a comparative example.

FIGS. 6A and 6B are cross-sectional views showing, in enlarged scale, the structure of the patterned medium of the first embodiment.

FIG. 7 is a perspective view which schematically shows the structure of a magnetic recording apparatus according to a second embodiment.

FIG. 8 is a characteristic graph showing the relationship between the surface asperity a DTR medium and the recording density.

FIG. 9 is a characteristic graph showing the relationship between the B (Boron) content in a non-recording part of a DTR medium and the recording density.

FIG. 10 is a characteristic graph showing the relationship between the position in thickness direction of the non-recording part of a DTR medium and the B (Boron) content.

FIG. 11 is a characteristic graph showing the relationship between a different of surface asperity Ra and an impact test pass ratio.

### DETAILED DESCRIPTION

In general, according to one embodiment, in a method of manufacturing a magnetic recording medium which is configured such that a ferromagnetic recording part is formed on a support substrate (the support substrate is also called a substrate) in a desired track pattern or a desired bit pattern, a ferromagnetic film is formed on a support substrate, and then a B thin film is formed on a region for isolating the ferromagnetic film between tracks or bits. Subsequently, ions are radiated on the B thin film. This enables to increase B content of the region of the ferromagnetic film, on which the B thin film has been formed, and nonmagnetize the region.

As has been described above, in the DTR media and BPM, the surface asperities need to be set at 10 nm or less. The inventors previously devised a patterned medium fabrication method which can suppress a side erase phenomenon and a side read phenomenon while securing levitation properties of the recording head, without carrying out a nonmagnetic material burying step or a planarization step. In this method, a 10-nm-thick portion of a 15-nm-thick ferromagnetic recording layer is physically removed, and the remaining 5-nm-thick is magnetically deactivated by ion beam etching (IBE) using a mixture gas of He (helium) gas and N₂ (nitrogen) gas. In this structure, although the physical asperity is 10 nm, magnetic isolation with a depth of 15 nm is effected.

However, in order to achieve a high recording density of 1 Tb/in² or more, it is notable to decrease as much as possible the gap (spacing) between the recording medium and the recording head, to improve the recording performance of the recording head, and to improve the linear recording density (bpi). As a method of temporarily decreasing the levitation amount of the recording head, dynamic flight height control (DFH) is known. By making use of the DFH, the space between the recording medium and the recording head can be temporarily minimized. However, if the surface asperity of the DTR medium/BPM is greater than 10 nm, the DFH control would become very unstable. Thus, order to achieve the recording density of 1 Tb/in² more, it is necessary to decrease the surface asperity of the DTR medium/BPM as much as possible.

Taking the above problem into account, the inventors have devoted themselves to studies and found that nonmagnetization (zero magnetization) can be achieved by mixing B (boron) in a ferromagnetic recording layer. If DTR medium/BPM is fabricated by making use of this phenomenon, the surface asperity can be reduced to 4 nm or less.

In order to mix B in the ferromagnetic recording layer, there is a method in which a solid B target is subjected to DC sputtering, and a film of B is selectively formed on a part which is to be nonmagnetized, and thereafter ions of He, Ne, or Ar are radiated. B is efficiently mixed in the ferromagnetic recording layer by the assistance of He, etc., and the ferromagnetic recording layer is nonmagnetized.

In general, as the ferromagnetic recording layer, a CoCrPt alloy is used in DTR media, and a CoPt alloy is used in BPM. If a mixing amount is less 5 at % by mixing B into the CoPt alloy, granulation of CoCrPt or CoPt is promoted and coercivity (Hc) increases. If the mixing amount is 5 at % or more and is less than 15 at %, the ferromagnetic recording layer becomes soft magnetic, and Hc is 1000 Oe or less. If the mixing amount is 15 at % or more, Hc becomes zero. In other words, by setting the mixing amount of B at 15 at % or more, the ferromagnetic recording part can surely be isolated.

The present embodiment is based on the above-described result of studies, and relates to a method of manufacturing a patterned medium which has good surface planarity and is adaptive to a recording density of 1 Tb/in² or more.

### First Embodiment

To begin with, in order to manufacture a patterned medium, a UV imprint stamper (resin stamper) is needed. A resin stamper, which is fabricated by a well-known method, can be used.

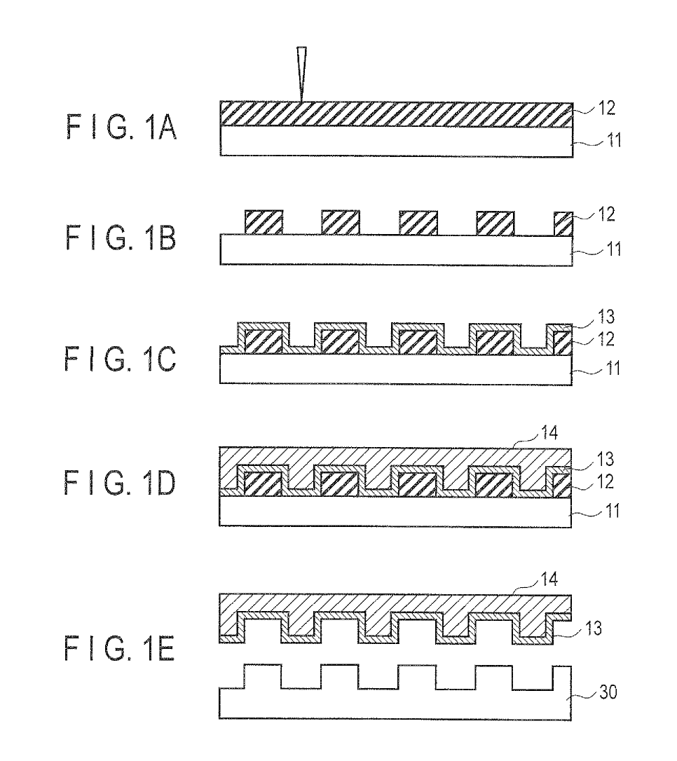

FIG. 1A to FIG. 1E are cross-sectional views illustrating fabrication steps of a UV imprint stamper, which is used in the first embodiment.

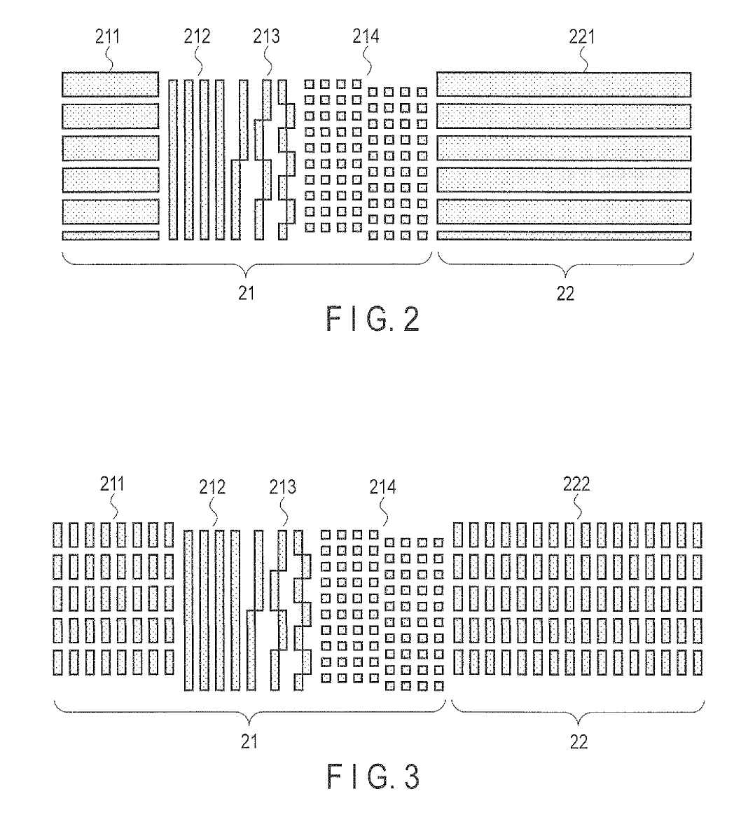

As shown in FIG. 1A, an electron beam (EB) drawing resist is spin-coated on a Si substrate 11 with a diameter of, e.g. 6 inches. Then, by prebaking the resultant structure for three minutes at 200° C., a resist layer 12 with a thickness of about 50 nm is formed on the Si substrate 11. Subsequently, using an EB drawing apparatus, a pattern shown in FIG. 2 or FIG. 3 was directly drawn on the resist layer 12 on the substrate 11. By developing the resist layer 12 by dipping it in a developing liquid for 90 seconds, a master disk, as shown in FIG. 1B, was fabricated.

Patterns of FIG. 2 and FIG. 3 are examples of sectors. FIG. 2 is an example of a DTR medium, and FIG. 3 is an example of a RPM. The sector is divided into a servo data area 21 on which a servo pattern is formed, and a record data area 22 for storing record data. The servo data area 21 is divided into a preamble pattern 211 for rotation control, a sector information pattern 212 for sector identification, a track information pattern 213 for identifying tracks in the radial direction, and a burst pattern 214 for aligning positions of tracks. In the case where the record data area 22 is continuous tracks 221, the record data area 22 becomes a so-called discrete track medium. Further, in the case where the record data area 22 is record bits 222 which are divided so as to correspond to each bit, the record data area 22 becomes a so-called bit patterned medium. The present embodiment is applicable to either medium.

Then, a Ni stamper was fabricated. Specifically, as shown in FIG. 12, a Ni conductive film 13 with a thickness of about 10 nm was formed on the master disk by sputtering. Subsequently, as shown in FIG. 1D, the master disk with the conductive film was dipped in a nickel sulfamate plating solution, and thereby a Ni plating layer 14 was formed. Then, the resist layer 12 adhering to the surface was removed by oxygen RIE, and thereby a Ni stamper was fabricated.

Thereafter, the Ni stamper was set in an injection molding apparatus, and a resin stamper 30 was fabricated by injection molding, as shown in FIG. 1E. Although a cyclic olefin polymer was used for a molding material of the resin stamper 30, polycarbonate material can also be used for the molding material.

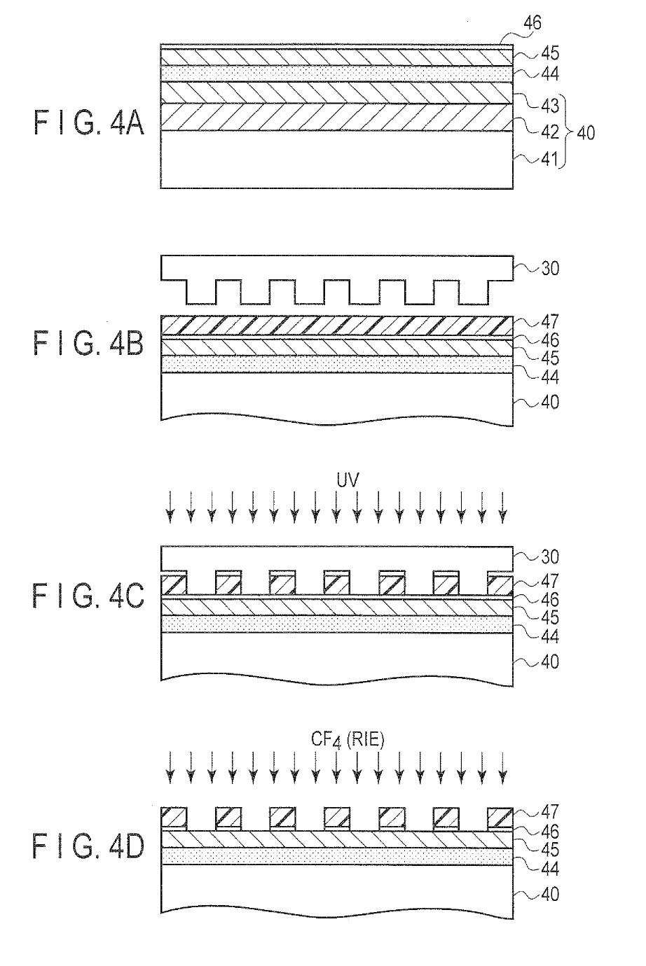

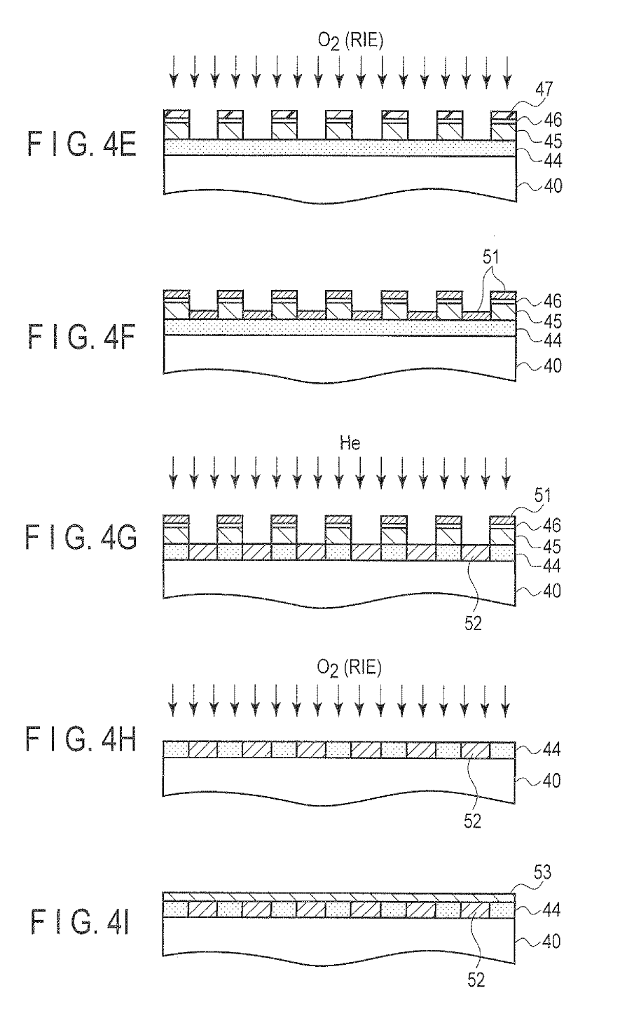

Next, referring to FIG. 4A to FIG. 4I, a process of manufacturing a patterned medium according to the present embodiment is described.

To begin with, as shown in FIG. 4A, a support substrate 40 was fabricated by forming a CoZrNb layer (soft magnetic layer) 42 with a thickness of 120 nm and a Ru layer (alignment control underlayer which is also called an underlayer) 43 with a thickness of 20 nm on a discoidal glass substrate 41. A CoCrPt—SiO₂ layer (ferromagnetic recording layer) 44 with a thickness of 15 nm was formed on the support substrate 40. For the ferromagnetic recording layer 44, CoCrPt or CoPt can also be used. Then, a C layer (protection layer) 45 with a thickness of 15 nm, which serves as a mask material layer, was formed on the ferromagnetic recording layer 44. Subsequently, an adhesion layer 46 (3 to 5 nm) for adhering a TV imprint resist to the magnetic recording medium was formed on the protection layer 45. The material of the adhesion layer 46 can be selected from among CoPt, Cu, Al, NiTa, Ta, Ti, Si, Cr, and NiNbZrTi. In this example, Si was used.

Subsequently, as shown in FIG. 45, a UV imprint resist 47 with a thickness of 50 nm was coated on the adhesion layer 46 by a spin coat method. The resist 47 was provided for forming a pattern by the resin stamper 30 which was fabricated in the process of FIG. 1A to FIG. 1E. The UV imprint resist 47 is a material having ultraviolet-curing properties, and is composed of a monomer, an oligomer and a polymerization initiator. For example, isobornyl acrylate (IBOA) can be used for the monomer, polyurethane diacrylate (PUPA) can be used for the oligomer, and Darocure (trademark) 1173 can be used for the polymerization initiator. Further, the composition of each component can be set to be IBOA 85%, PUPA 10% and polymerization initiator 5%.

Next, as shown in FIG. 4C, the resin stamper 30 was adhered to the resist 47, and UV imprint was performed by radiating ultraviolet from the back side of the stamper 30.

Then, as shown in FIG. 4D, after the resin stamper 30 was peeled from the resist 47, an imprint residual was removed by using a CF₄ plasma, or an argon ion beam. For example, etching is performed by using a CF₄ plasma for 15 seconds in an RIE apparatus with a chamber pressure of 0.3 Pa and an input power of 100 W. This process enables to remove a residual formed in the imprint process and the Si adhesion layer 46.

Subsequently, as shown in FIG. 4E, a C mask was fabricated by etching the protection film 45 by using an ICP etching apparatus (e.g. chamber pressure: 0.3 Pa, input power: 100 W) using oxygen gas. When this etching is finished, a major part of the resist 27 is removed.

As the mask material, C, Mo, Ta, Ti, W or Cu can be used. When Mo, Ta, Ti or W is used as the mask material, it is suitable to use RIE using a fluorine-based gas a mask peel step (FIG. 4G) which is being described later. The fluorine-based gas refers to CF₄, C₂F₈, CHF₃, and SF₆ or the like. When mask peel is performed by RIB using the fluorine-based gas, re-adhesion matter will occur, so it is advisable to perform a washing step after the mask peel step. Such metallic masks can efficiently shield ions in an ion radiation step (FIG. 4F). This step is being described later. Cu can be used as the material of the metallic mask with a high shield effect. In the case where Cu is used for the mask, the mask peel is performed by Ar ion etching since the mask cannot be peeled by oxygen RIE or fluorine RIE. The mask can be easily peeled since Cu has a low resistance to Ar ion etching.

Subsequently, as shown in FIG. 4F, a B thin film 51 is formed by DC sputtering using a solid B (boron) target. The thickness of the B thin film should be, notably, 10 nm or less, and more notably 5 nm or less. In this example, a B thin film with a thickness of 3 nm was formed at a low pressure (0.5 Pa).

Then, as shown in FIG. 4G, ions were radiated in order to mix B. Inactive light elements are notable as the ions, and He, Ne or Ar is notable. Since lighter elements can enter the ferromagnetic material to a greater depth at low acceleration, the light element is suitable for the mixing of B. In this example, He gas was ionized by electron cyclotron resonance (ECR), and He ions were radiated on a sample at an acceleration voltage of 1000 kV. Though this process, a B film formed on the sample surface is diffused and mixed in the ferromagnetic recording layer 44, and magnetism is deactivated. Thereby, a magnetism-deactivated part 52 is formed.

In this case, since the magnetism-deactivated part 52 is formed by mixing B in the ferromagnetic recording layer 44, the volume of the magnetism-deactivated part 52 becomes greater than that of the original ferromagnetic material. Hence, the level of the surface of the magnetism-deactivated part 52 becomes higher than the level of the surface of the ferromagnetic recording layer 44, and the surface asperity of the magnetism-deactivated part 52 increases.

Subsequently, as shown in FIG. 4H, an oxygen plasma process was performed by RIE (e.g. 13 Pa, 100 W, etching time of 30 seconds) using oxygen gas, thereby removing the C mask and the B thin film 51 formed on the mask.

When the B thin film 51 is formed in the step of FIG. 4F, the adhesion of B to the side surface of the C mask can be suppressed by using low-pressure sputtering, and the mask and the B-thin film 51 can effectively be removed by lift-off in a dry process.

If the thickness of the B thin film 51 is too great or if the B thin film 51 is formed by high-pressure sputtering, B would adhere to the side wall of the C mask, and the lift-off in the dry process would become difficult. In this case, lift-off in a wet process can be used. In order to perform lift-off in a wet process, a lift-off layer (e.g. Mo, Mg, etc.) is formed after the ferromagnetic recording layer 44 is formed in the step of FIG. 4A. Then, the C protection layer 45 is successively formed on the lift-off layer. Since the lift-off layer is dissolved in a hydrogen peroxide solution (H₂O₂), the lift-off layer is dipped in the H₂O₂ solution, instead of performing the oxygen plasma process in the step of FIG. 4H. Thereby, the C mask and B thin film 51 on the Mo or Mg can be removed.

The lift-off in the wet process is advantageous in that process damage to the ferromagnetic recording layer 44 can be suppressed, since no oxygen plasma is used. However, there is a risk of occurrence of a stain on the sample surface. In such a case, two-fluid washing, ultrasonic washing, megasonic washing and scrub washing may be combined.

At last, as shown in FIG. 4I, a surface C protection film 53 with a thickness of 4 nm is formed by chemical vapor deposition (CVD), and a lubricant is coated on the surface C protection film 53. Thus, the DTR medium or BPM can be obtained.

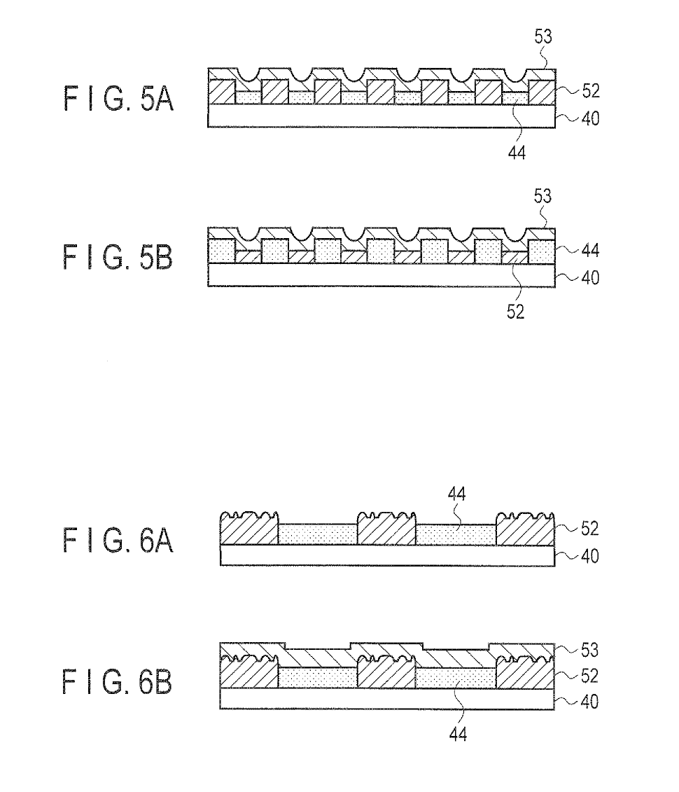

The structure of the thus fabricated patterned medium of the present embodiment is characterized, as shown in FIG. 5A, that the upper surface of the non-recording part (magnetism-deactivated part) 52 is slightly higher than the upper surface of the ferromagnetic recording layer (recording tracks, bits) 44. Specifically, in this structure, the surface asperity is 4 nm or less, the ferromagnetic recording layer 44 is a recessed part, and the magnetism-deactivated part 52 is a projecting part. This structure is reverse to a conventional structure shown in FIG. 5B. In addition, as shown in FIG. 6A and FIG. 6B, the surface asperity of the magnetism-deactivated part 52, which is a projecting part, is greater than that of the ferromagnetic recording layer 44 which is a recessed part. The reason for this is that the volume was increased by the mixing of B.

The patterned medium of this embodiment has a feature that an HDD where the patterned medium installed resists an impact such as a drop. The reason is as follows. When the recording head comes in contact with the patterned medium due to the impact such as a drop, the contacted recording part is broken and rendered non-recordable if the head contacts the recording part. However, in the structure of the present embodiment, the non-recording part contacts with the head because not the ferromagnetic recording part but the magnetism-deactivated part is the projecting part. Therefore, even if the recording head comes in contact with the patterned medium and the patterned medium is broken, recording status is kept because only the non-recording part is broken. In other words, in the conventional patterned media recording apparatus, the risk of losing a record of the user data due to an impact such as a drop is very high, but in the patterned media recording apparatus of the present embodiment, the risk of losing a record due to, e.g. a drop is low.

In the case where the non-recording part and the recording part are formed of different materials in different fabrication steps, the adhesion between the non-recording part and recording part is poor, and there is a very high possibility of breakage due to an impact such as a drop. By contract, in the present embodiment, the magnetism-deactivated part 52 is constructed by partly denaturing the ferromagnetic recording layer 44 with B. Thus, the recording part and non-recording part are thin films which are formed of the same material in the same fabrication step. Therefore, the durability is remarkably improved, compared to the case in which the non-recording part and the recording part are formed of different materials in different fabrication steps.

The conventional patterned medium comprises a non-recording part which is formed of a nonmagnetic material, and a recording part which is formed of a ferromagnetic material. It is known that the surface of the nonmagnetic material has poor adhesion to a protection film C. Although the protection film C is formed by CVD, the CVD is a film forming method which is greatly affected by an underlayer. If a film of C is formed by CVD under conditions corresponding to the ferromagnetic material, the strength of C, which is formed on the nonmagnetic material, lowers. For example, in order to perform CVD, it is notable to heat the surface of the patterned medium up to about 200° C. If lamp heating is conducted in a vacuum, the ferromagnetic material is easy to be heated, and the nonmagnetic material is hard to be heated. In the case of the condition that the ferromagnetic material is heated up to 200° C., the temperature of the surface of the nonmagnetic part does not rise to 200° C. Thus, CVD film formation is performed locally at low temperatures on the nonmagnetic part alone, and the quality of the protection film C deteriorates and the strength lowers.

The non-recording part of the patterned medium of the embodiment is formed by adding B to the ferromagnetic recording layer which is formed in the above-described step of FIG. 4A. Hence, even if lamp heating is conducted in a vacuum, the temperature rise ratio is substantially equal between the recording part and the non-recording part. Therefore, a strong C protection film, which is free from a local temperature variation as in the prior art, can be fabricated. The degradation in strength of the C protection film is closely related to the adhesion to the underlayer, and the C protection film, which is more difficult to peel and is stronger, is obtained as the adhesion is higher.

In addition, as the surface asperity of the underlayer is higher, the adhesion between the underlayer and the C protection film 53, which is formed on the underlayer, is higher. Thus, in the patterned medium of the present embodiment, by intentionally increasing the surface asperity of the non-recording part 52, the strength of adhesion between the C protection film 53 and the non-recording part is increased. Thereby, a high resistance is obtained to the breakage of the patterned medium recording apparatus due to an impact such as a drop.

As has been described above, according to the present embodiment, the magnetism-deactivated part 52 is formed in the ferromagnetic recording layer 44 by making use of the formation of the B thin film 51 and the mixing by ion irradiation. Thereby, a magnetic recording medium, in which the surface asperity can be reduced, can be manufactured without incurring process damage or increase in number of fabrication steps. Moreover, since the surface level of the non-recording part 52 is higher than that of the recording part 44, this enables to resist an impact such as a drop. Besides, since the surface asperity of the non-recording part 52 is large, the adhesion to the surface protection layer is improved, and the reliability can further be enhanced.

### Second Embodiment

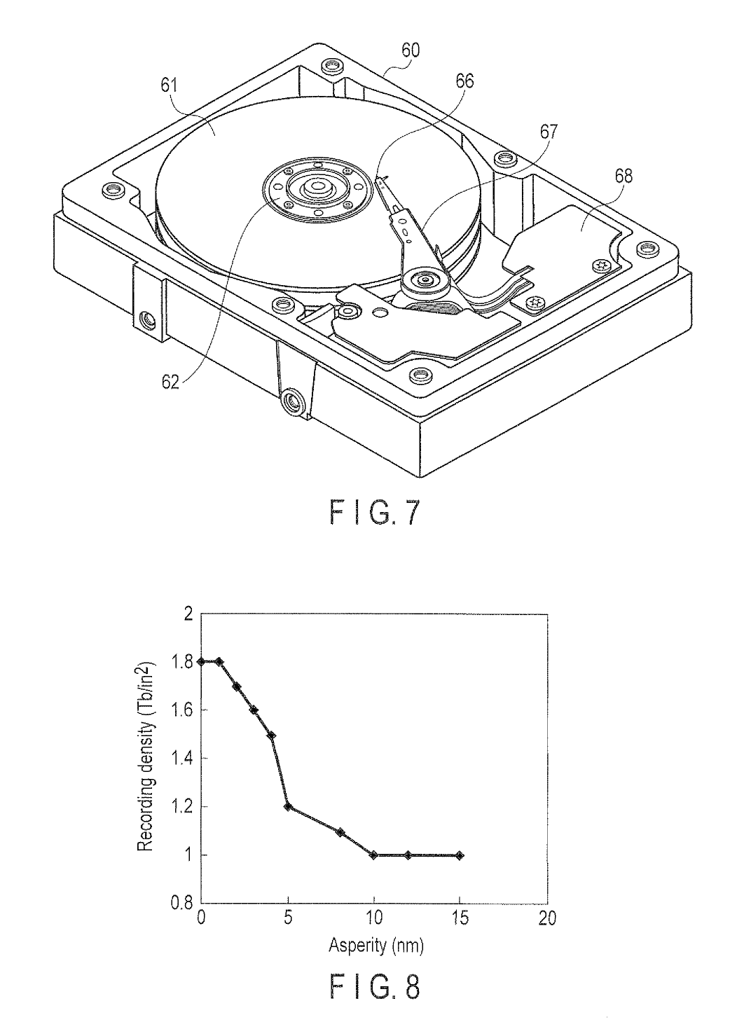

FIG. 7 is a perspective view which schematically shows the structure of a hard disk drive (magnetic recording apparatus) using a patterned medium.

This apparatus is of a type using a rotary actuator. A housing 60 includes a magnetic disk (magnetic recording medium) 61, a spindle motor 62, a head slider 66 including a magnetic head, a head suspension assembly 67 which supports the head slider 66, a voice coil motor 68, and a circuit board (not shown).

The magnetic disk 61 is a patterned medium, on which various kinds of digital data are recorded by a perpendicular magnetic recording method. The magnetic disk 61 is mounted on the spindle motor 62 and is rotated. The present apparatus can comprise a plurality of magnetic disks 61.

The head slider 66, which records/reproduces information in/from the magnetic disk 61, is attached to a distal end of a thin-film-shaped suspension. The head slider 66 has a magnetic recording head mounted on a distal end portion thereof. The magnetic head, which is assembled in the head slider 66, is a so-called composite head, and includes a single-pole-type write head and a read head which uses a shield-type MR reproduction element (e.g. GMR or TMR).

The basic structure of the apparatus is the same as that of a conventional apparatus. However, the present embodiment differs from the conventional apparatus in that the patterned medium that is fabricated in the first embodiment is used as the magnetic disk 61. By using the patterned medium 61, the recording density can further be increased. In addition, as described above, the magnetism-deactivated part of the patterned medium 61 projects higher than the ferromagnetic recording part. Thus, even if the recording head and the patterned medium come in contact with each other due to an impact such as a drop, only the non-recording part is broken. Therefore, there is an advantage that the risk of losing a record due to, e.g. a drop is low.

Examples, which concretely illustrate the present embodiment, are being described.

### Example 1

By the method illustrated in FIG. 4A to FIG. 4I, a DTR medium with 1 Tb/in² (track pitch TO: 50 nm) was fabricated. The DTR medium was fabricated by using He as an irradiation ion species, and by using a wet lift-off method adopting a Mo lift-off layer. The surface asperity was 4 nm. The fabricated DTR medium was assembled in the drive. The bit error ratio (BER) was measured, and the BER of 10⁻⁷ was obtained.

Subsequently, a recording density test using DFH was conducted, and the recording with a recording density of 1.5 Tb/in² was confirmed. The reason for this is that the DFH could be strongly effected since the surface asperity was less than in the conventional DTR medium.

According to the present example, the solid B is adhered onto the etching mask, and assist ions (He) are radiated. Thereby, a DTR medium with a small surface asperity and a high recording density can be fabricated.

In the case of the present example, in the state in which DFH is not used, the BER is BER=10⁻⁷ at the recording density of 1 Tb/in². Using this state as a reference, the recording capability is improved by decreasing the levitation amount of the recording head from this state with use of DFH, and the bpi (bit-direction density) is increased by increasing the recording frequency. In usual cases, if DFH is used, the recording capacity increases but the BER deteriorates. The density in the state in which the BER deteriorates to 10^{-5.5} (the lower limit of the operation of the patterned medium-equipped apparatus) was set to be the “maximum recording density” in the patterned medium. In the description of this specification, the estimation of the recording density by this test is referred to as a recording density test.

### Example 2

When the film of B was formed in the step of FIG. 4F, low-pressure sputtering at 0.5 Pa was used. By setting this condition, B did not adhere to the side surface of the C mask, and the mask peel by oxygen RIE was successfully carried out in the step of FIG. 4H. In this case, the number of surface particles on the surface of the fabricated DTR medium was 20 or less.

Tests were conducted by varying the B film formation pressure in the range of 0.5 to 9 Pa. Under the film formation condition of 0.5 Pa or more, and less than 1.0 Pa, B did not adhere to the side wall of the C mask, and the mask peel by oxygen RIE, was successfully performed in the step of FIG. 4H. When the B film was formed at a pressure of 1.0 Pa or more and 9.0 Pa or less, it was found that B adheres to the side wall of the C mask, and the mask peel by oxygen RIE, could not be performed.

Then, after the ferromagnetic recording layer 44 was formed in the step of FIG. 4A, a film of Mo with a thickness of 1 nm was formed as a lift-off layer, and the C protection layer 45 was formed on the lift-off layer, and thus the mask was formed. Thereby, the mask peel (the step of FIG. 4H) was successfully performed by wet lift-off using hydrogen peroxide (H₂O₂). In this case, since oxygen RIE is not used for the C mask peeling, process damage due to oxidation can completely be suppressed. However, the number of surface particles on the surface of the fabricated DTR medium was 40 or less, and slightly increased.

As has been described above, according to the present example, when the condition for forming the B thin film is 0.5 Pa or more and 1.0 Pa or less, the DTR medium with a very small number of surface particles can be fabricated. In addition, when the condition for forming the B thin film is 1.0 Pa or more and 9.0 Pa or less, the oxidation process damage can completely be suppressed.

### Example 3

DTR media (TP: 50 nm) were fabricated by the same method as in Example 1, except that Ne and Ar were used as the irradiation ion species. The asperity of the DTR medium fabricated by using Ne ions was 3 nm, and the asperity of the DTR medium fabricated by using Ar ions was 2 nm. The reason for this is that the “sputter etch effect”, as well as “mixing effect”, is obtained by the ion species radiated in the step of FIG. 4G. In short, Ne and Ar have stronger “sputter etch effect” than He.

The fabricated DTR media were assembled in the drive, and the recording density was calculated by using DFH. In all samples, the recording with the recording density of 1.5 Tb/in² was confirmed. As the asperity becomes smaller, the density should be improved by the effect of the DFH. However, the result was the same as in the case of He (Example 1). The reason is as follows. Since Ne and Ar have a strong “sputter etch effect”, the asperity can be decreased and the DFH can be increased by that much. On the other hand, Ne and Ar have a weaker “mixing effect”. The effect of the improvement of the recording density is canceled by the “sputter etch effect” and “mixing effect”.

As has been described above, the same result as in Example 1 is obtained even when the gas species that is radiated on the B thin film is Ne or Ar.

### Example 4

A DTR medium (TO: 50 nm) was fabricated by the same method as in the above-described Example 1. Cross-sectional transmission electron microscope (TEM) measurement of the DTR medium was conducted. It was confirmed that the DTR medium had the structure (the structure of FIG. 5) in which a projection part was a non-recording part and the asperity was 4 nm.

Then, DTR media with different asperities were fabricated by varying the process condition of the above-described step of FIG. 4F. Specifically, the acceleration voltage, the gas flow rate and the in-chamber pressure were varied. Samples with asperities of 0 to 18 nm were fabricated. In order to realize the asperity of 0 nm, it is necessary to reduce the acceleration voltage to the minimum of the specifications of the apparatus, and as a result the process time increases to several-ten minutes. In the case of samples with the asperity of 1 nm or more, since the acceleration voltage can be set at a general value (300 kV or more), the process time is several minutes or less.

Recording density tests were conducted, and the relationship between the asperity and recording density was examined, as shown in FIG. 8. In the samples with the asperity of 15 nm or more, the recording head did not levitate, and recording density tests could not be conducted. The recording density was constant in the case where the asperities were in the range of 10 to 15 nm, and there was a tendency that the recording density was higher as the asperity was smaller in the case where the asperities were 8 nm or less. In addition, when the asperity was 4 nm or less, the recording density was remarkably improved, and was 1.5 times higher than the reference. From this result, the recording density is better as the asperity is smaller, and the suitable asperity is 8 nm or less, and notably 4 nm or less. However, as regards the sample with the asperity of 0 nm, the process time of the step of FIG. 4G has to be considerably increased. Thus, from the standpoint of fabrication, the suitable asperity is notably 1 nm or more and 4 nm or less.

According to the present example, as described above, by designing the surface asperity (the difference in level between the recording part and non-recording part) at 1 nm or more and 4 nm or less, both the high recording density and the fabrication efficiency can be satisfied.

### Example 5

A DTR medium (TP: 50 nm) was fabricated by the same method as in the above-described Example 1. Cross-sectional TEM measurement of the DTR medium was conducted. It was confirmed that the DTR medium had the structure (the structure of FIG. 5) in which a projection part was a non-recording part and the asperity was 4 nm. The physical composition of the projecting non-recording part was analyzed by energy dispersive X-ray spectroscopy (EDX), and it was found that the projecting non-recording part is composed of the elements of Co, Cr, Pt and B. The B content was 15 at %.

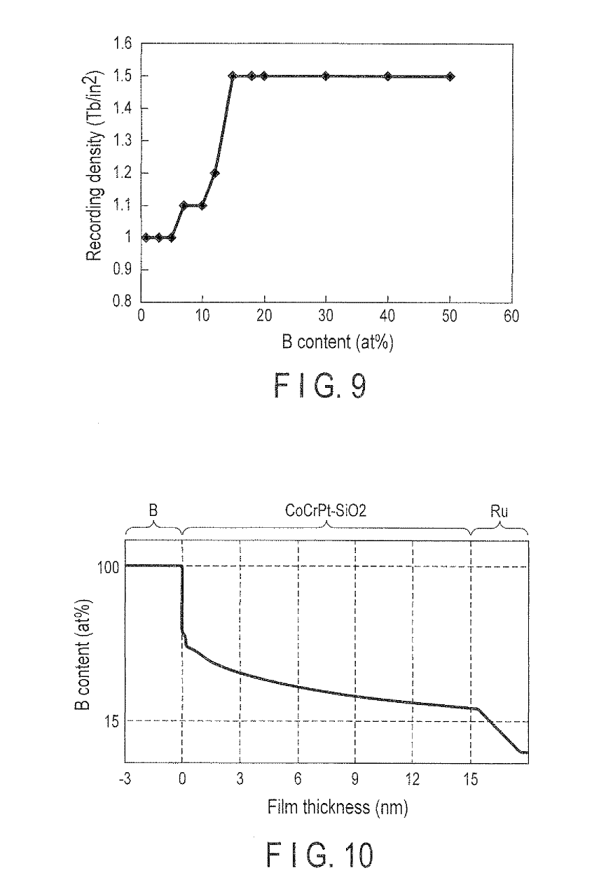

Then, DTR media were fabricated by varying the conditions of the above-described steps of FIG. 45 and FIG. 4G. FIG. 9 shows the amount of B analyzed by EDX, and results of recording density tests using DFH. As the B content in the non-recording part increases, the recording density becomes higher. The improvement of the recording density is saturated when the B content is 15 at % or more. When the B content is 8 at % or more, the improvement in density is observed, compared to the reference (1.0 Tb/in²), but the degree of improvement in density is 1.1 times higher and is not so great.

Subsequently, recording density tests using DFH were conducted. Samples, on which recording of 1.5 Tb/in² could be confirmed, were analyzed by EDX, and it was found that the B content was 15 at %. Samples were fabricated by varying the process conditions of the steps of FIG. 4F and FIG. 4G, and when the B content was examined by EDX, substantially the same result as in FIG. 9 was obtained. From this result, it was understood that the performance of the patterned medium is determined not by the method of fabrication, but by the amount of B in the non-recording region. It is suitable to set the B content at 8 at % or more, and notably 15 at % or more. If an increasing amount of B is mixed in a CoPt-based alloy, soft magnetization occurs if the B content is at % or more and is less than 15 at %. Thus, it is possible that soft magnetization is caused in a non-recording part of a DTR medium in which the B content is 8 at % or more and is less than 15 at %, and that an unexpected fault may occur. The content of 50 at % or more is excessive for fabricating the non-recording part, and is not desirable since a thin-film surface may be roughened.

In this case, in order to enhance the detection sensitivity, the B content was measured under the condition that all B content, which is present down to a depth of about 20 nm from the sample surface, was measured. As shown in FIG. 10, the actual B content is not constant in the depth direction of the magnetic layer. Thus, the B content described here indicates an average B content included in the magnetic layer.

Subsequently, a depth-directional analysis by EDX was conducted of the non-recording part of the fabricated DTR medium (Example 1). FIG. 10 is a conceptual view of the B content. Since the B thin film, which was formed in the step of FIG. 4F, is present on the uppermost surface, the B content is 100 at %. By the effect of the ion irradiation (FIG. 4G), B is mixed in the ferromagnetic layer (CoOrPt—SiO₂), and the B content gradually decreases as the depth increases. The B content sharply decreases in the underlying Ru layer. This is because of the acceleration voltage (1000 V) at which the radiated ions hardly reach the Ru layer.

According to the present example, as described above, by setting the B content at 15 at % or more and at less than 50 at %, both the surface planarity and the high recording density can be satisfied.

### Example 6

DTR media (TP: 50 nm) were fabricated by the same method as in the above-described Example 1, and magnetic recording apparatuses as shown in FIG. 7 were fabricated. Impact tests were conducted by dropping the magnetic recording apparatuses from the height of 2 m. Faults occurred in three of fifty apparatuses. Subsequently, the same tests were conducted by incorporating DTR media, which were fabricated by a general method, into magnetic recording apparatuses, and faults were confirmed in 23 apparatuses, or about half the apparatuses. It turned out that the magnetic recording apparatus, in which the patterned medium of the present example is mounted, has high resistance to an impact such as a drop.

According to the present example, as described above, the patterned medium has a strong protection film, and has high resistance to an impact such as a drop.

### Example 7

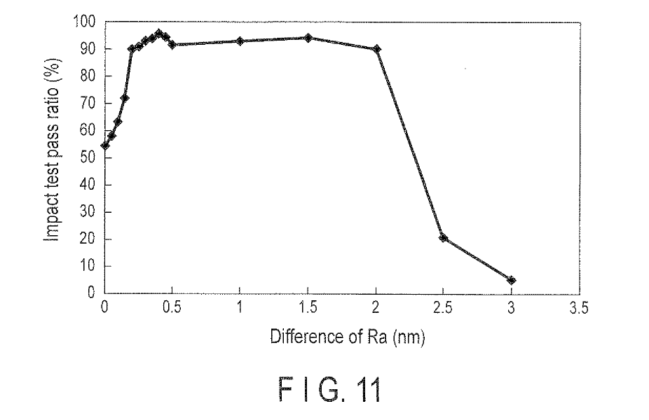

The apparatus, which underwent the impact test in the above-described Example 6, was disassembled, and the surface of the mounted DTR medium was measured by an atomic force microscope (AFM). The result was that the recording part surface asperity (Ra) was 0.65 nm, and the non-recording part Ra was 1.00 nm. It was considered that the difference of Ra between the recording part and the non-recording part was related to the C protection film strength of the patterned medium. The relationship between the Ra difference, between the non-recording part and recording part, and the impact test pass ratio (the probability that the apparatus including the DTR medium does not abnormally operate after an impact is applied to the apparatus) was examined. As a result, characteristics as shown in FIG. 11 were obtained.

Samples having the difference of Ra in the range of 0.2 nm or more and 2.0 nm or less have the pass ratio of 90% or more. Samples having the difference of Ra of less than 0.2 nm have low impact test pass ratios, and this reflects the fact that the strength of the C protection film on the recording part and the strength of the protection film on the non-recording part are greatly different and the resistance to impacts lowers. Samples having the difference of Ra of more than 2.0 nm have extremely low impact test pass ratios, and this is because the Ra of the non-recording part deteriorates (about 3 nm), the levitation properties of the recording head deteriorate, and the resistance to impacts lowers.

According to the present example, the resistance to impacts can be increased by setting the difference of Ra between the non-recording part and recording part at 0.2 nm or more and 2.0 nm or less.

### Example 8

The principle verification was conducted for fabricating the patterned medium by the manufacturing method according to the present embodiment. Samples were fabricated by the same manufacturing method as in FIG. 4A to FIG. 4I, except that patterns are not formed. Magnetization was examined by a vibrating sample magnetometer (VSM), and zero magnetization was confirmed. Although ions of He, Ne and Ar were confirmed, magnetization was zero in all samples. Subsequently, samples, in which ion irradiation was not conducted in the step of FIG. 4G, were fabricated, and the magnetization intensity was similarly measured by the VSM. The measurement result of 450 emu/cc was obtained.

By these fundamental studies, it was understood that the magnetization intensity of the magnetism-deactivated part is zero and the magnetization intensity of the recording part is about 450 emu/cc which is equal to a value of a general perpendicular recording film.

### Example 9

A BPM was fabricated by the same method as in Example 1, except that the pattern shown in FIG. 3 was drawn by EB drawing. The bit size of the fabricated BPM was 20 nm×20 nm. As regards the BPM, the definition of the BER is not possible, so a comparison based on signal amplitude intensity was made. Magnetization was fixed in one direction, and the BPM was assembled in the drive. The reproduction waveform was observed, and a signal amplitude intensity of 200 mV was obtained.

In this manner, it was found that the BPM can be fabricated by the same method as the DTR media.

### (Modifications)

The present invention is not limited to the above-described embodiments and examples.

In the embodiments, the glass substrate is used, but use may also be made of an Al-based alloy substrate, a ceramic substrate, a carbon substrate, a Si single-crystal substrate with an oxidized surface, and these substrates which are plated with NiP, etc. The glass substrate is, for instance, an amorphous glass or a crystalline glass. As the amorphous glass, use may be made of general-purpose soda lime glass, or aluminosilicate glass.

As the crystalline glass, use may be made of lithium-based crystalline glass. As the ceramic substrate, use may be made of a sintered body mainly comprising general-purpose aluminum oxide, aluminum nitride or silicon nitride, or a fiber-reinforced body thereof. As the substrate, use may be made of, as well as the above-described metallic substrate, a nonmetallic substrate on which a NiP layer is formed by plating or sputtering. A general method of forming a thin film on the substrate is sputtering, but the same effect can be obtained by vacuum evaporation or electroplating.

A soft magnetic layer (soft underlayer) (SUL) has a part of the function of a magnetic head, which causes a recording magnetic field from a magnetic head for magnetizing a perpendicular magnetic recording layer, for instance, a single-pole-type head, to flow back to the magnetic head side in the horizontal direction. Further, the soft magnetic layer (soft underlayer) may have a function of applying a sharp, sufficient perpendicular magnetic field to the recording layer in the field, and improving the recording efficiency. Thus, a material including Fe, Ni, or Co may be used for the soft magnetic layer (soft underlayer).

Examples of such materials are as follows. Examples of a FeCo-based alloy include FeCo and FeCoV. Examples of a FeNi-based alloy include FeNi, FeNiMo, FeNiCr and FeNiSi. Examples of a FeAl-based alloy and a FeSi-based alloy include FeAl, FeAlSi, FeAlSiCr, FeAlSiTiRu, and FeAlO. Examples of a FeTa-based alloy include FeTa, FeTaC and FeTaN. Examples of a FeZr-based alloy include FeZrN. As the material of the soft magnetic layer, use may be made of a material having a microcrystalline structure of FeAlO, FeMgO, FeTaN, FeZrN, etc. including 60 at % of Fe, or a material having a granular structure in which fine crystalline particles are disposed in a matrix.

Other usable materials of the soft magnetic layer include a Co alloy including Co and at least one selected from among Zr, Hf, Nb, Ta, Ti and Y. Notably, 80 at % of Co is included. When a film of such a Co alloy is formed by sputtering, an amorphous layer tends to be easily formed. The amorphous soft magnetic material exhibits very excellent soft magnetism since it is free from crystal magnetic anisotropy, crystal defects, or grain boundaries. By using the amorphous soft magnetic material, the noise of the medium can be reduced. Examples of a suitable amorphous soft magnetic material include CoZr, CoZrNb, and a CoZrTa-based alloy. Under the SUL, an additional underlayer may be provided in order to improve the crystallinity of the SUL or to improve the adhesion to the substrate.

As the material of the underlayer, use may be made of Ti, Ta, W, Cr or Pt, or an alloy including these elements, or an oxide or a nitride thereof. An intermediate layer, which is formed of a nonmagnetic material, may be provided between the SUL and the recording layer. The intermediate layer has two functions, that is, a function of shutting off an exchange coupling interaction between the SUL and the recording layer, and a function of controlling the crystallinity of the recording layer. Examples of the material of the intermediate layer include Ru, Pt, Pd, W, Ti, Ta, Cr or Si, or an alloy including these elements, or an oxide or a nitride thereof. In order to prevent spike noise, the SUL may be divided into a plurality of layers, and antiferromagnetic coupling may be effected by inserting Ru with a thickness of 0.5 to 1.5 nm. Besides, a pinned layer, which is formed of a hard magnetic film with in-plane anisotropy of CoCrPt, SmCo, FePt, etc., or an antiferromagnetic material such as IrMn, PtMn, etc., may be exchange-coupled to the soft magnetic layer. In this case, in order to control the exchange coupling force, magnetic films (e.g. Co) or nonmagnetic films (e.g. Pt) may be stacked on both sides of the Ru layer.

It should suffice if the ferromagnetic recording layer (perpendicular magnetic recording layer) is formed of a material including Co as a main component and including at least Pt. A material including Cr or an oxide, in addition to these components, may be used. In particular, silicon oxide or titanium oxide is suitable as the oxide. Notably, magnetic particles (crystalline particles having magnetism) should be dispersed in the perpendicular magnetic recording layer. Notably, the magnetic particles should have columnar structures vertically penetrating the perpendicular magnetic recording layer. By forming such structures, the alignment and crystallinity of the magnetic particles of the perpendicular magnetic recording layer can be made excellent and, as a result, a signal/noise ratio (S/N ratio) that is suitable for high-density recording can be obtained. In order to obtain such structures, the amount of the contained oxide is important. The content of the oxide should be, notably, 3 mol % or more and 12 mold or less, relative to the total amount of Co, Cr and Pt. More notably, the content of the oxide should be 5 mol % or more and 10 mol % or less.

The above-mentioned range is notable as the content of the oxide in the perpendicular magnetic recording layer, because when the layer is formed, the oxide is precipitated around the magnetic particles and the magnetic particles can be isolated and made finer. When the content of the oxide exceeds the above-described range, the oxide remains in the magnetic particles, the alignment and crystallinity of magnetic particles are degraded, and further the oxide is precipitated on the upper and lower sides of the magnetic particles. As a result, the columnar structure, in which the magnetic particles vertically penetrate the perpendicular magnetic recording layer, is undesirably not formed. When the content of the oxide is less than the above-described range, the isolation and reduction in size of magnetic particles are not sufficient. As a result, undesirably, the noise at the time of recording increases, and the signal/noise ratio (S/N ratio) that is suitable for high-density recording cannot be obtained.

The Cr content of the perpendicular magnetic recording layer should be, notably, 16 at %. More notably, the Cr content should be 10 at % or more and 14 at % or less. The Cr content is set in the above range because a uniaxial crystal magnetic anisotropy constant Ku of magnetic particles is not excessively lowered, high magnetization is maintained, and, as a result, recording characteristics suitable for high-density recording and sufficient heat fluctuation characteristics can be obtained. If the Cr content exceeds the above-described range, the Ku of the magnetic particles decreases, and consequently the heat fluctuation characteristics deteriorate and the crystallinity and alignment of the magnetic particles are degraded. As a result, the recording characteristics deteriorate.

The Pt content of the perpendicular magnetic recording layer should be, notably, 10 at % or more and 25 at % or less. The Pt content is set in the above range because the Ku that is necessary for the perpendicular magnetic layer is obtained, the crystallinity and alignment of the magnetic particles are good, and, as a result, heat fluctuation characteristics and recording characteristics suitable for high-density recording can be obtained. If the Pt content exceeds the above-described range, a layer of an foe structure may undesirably be formed in the magnetic particles, and the crystallinity and alignment of the magnetic particles may be degraded. If the Pt content is less than the above-described range, the Ku for obtaining heat fluctuation characteristics, which are suitable high-density recording, cannot be obtained undesirably.

The perpendicular magnetic recording layer may include, in addition to Co, Cr, Pt and the oxide, at least one element selected from among B, Ta, Mo, Cu, Nd, W, Nb, Sm, Tb, Ru and Re. By the inclusion of such elements, the reduction in size of the magnetic particles can be promoted, or the crystallinity and alignment can be improved, and recording characteristics and heat fluctuation characteristics, which are more suitable for high-density recording, can be obtained. The total content of the above-mentioned elements should be, notably, 8 at % or less. When the total content exceeds 8 at %, a phase other than an hcp phase is formed in the magnetic particles, and hence the crystallinity and alignment of magnetic particles are degraded. As a result, the recording characteristics and heat fluctuation characteristics, which are suitable for high-density recording, cannot be obtained.

As the material of the perpendicular magnetic recording layer, use may be made of, in addition to the above, a CoPt-based alloy, a CoCr-based alloy, a CoPtCr-based alloy (CoPtO, CoPtCrO, CoPtSi, CoPtCrSi), a multilayer structure of an alloy including as a main component at least one selected from the group consisting of Pt, Pd, Rh and Ru, and Co, and CoCr/PtCr, CoB/PdB, and CoO/RhO which are obtained by adding Cr, B and O to the multilayer structure.

The thickness of the perpendicular magnetic recording layer is notably 5 to 60 nm, and more notably 10 to 40 nm. If the thickness is in this range, the magnetic recording apparatus can operate as one which is more suitable for high recording density. If the thickness of the perpendicular magnetic recording layer is less than 5 nm, there is a tendency that the reproduction output is too low and the noise component becomes higher than the reproduction output. If the thickness of the perpendicular magnetic recording layer exceeds 40 nm, there is a tendency that the reproduction output is too high and the waveform is distorted. The coercivity of the perpendicular magnetic recording layer should be, notably, 237000 A/m (3000 Oe) or more. If the coercivity is less than 237000 A/m (3000 Oe), there is a tendency that the resistance to heat fluctuation deteriorates. The perpendicular squareness ratio of the perpendicular magnetic recording layer should be, notably, 0.8 or more. If the perpendicular squareness ratio is less than 0.8, there is a tendency that the resistance to heat fluctuation deteriorates.

The UV imprint resist is a material having ultraviolet-curing properties, and is composed of a monomer, an oligomer, and a polymerization initiator. No solvent is included. Examples of the monomer material are as follows.

### *Acrylates

Bisphenol A-ethylene oxide-denatured diacrylate (DPEHA)
Dipentaerythritol hexa(penta)acrylate (DPEHA)
Dipentaerythritol monohydroxypentaacrylate (DPEHPA)
Dipropylene glycol diacrylate (DPGDA)
Ethoxylated trimethylolpropane triacrylate (ETMPTA)
Glycerin propoxy triacrylate (GPTA)
4-hydroxybutyl acrylate (HBA)
1,6-hexanediol diacrylate (HDDA)
2-hydroxyethyl acrylate (HEA)
2-hydroxypropyl acrylate (HPA)
Isobornyl acrylate (IBOA)
Polyethylene glycol diacrylate (PEDA)
Pentaerythritol triacrylate (PETA)
Tetrahydrofurfuryl acrylate (THFA)
Trimethylolpropane triacrylate (TMPTA)
Tripropylene glycol diacrylate (TPGDA)

### *Methacrylates

Tetraethylene glycol dimethacrylate (4EDMA)
Alkylmethacrylate (AKMA)
Arylmethacrylate (AMA)
1,3-butylene glycol dimethacrylate (BDMA)
n-butylmethacrylate (BMA)
Benzylmethacrylate (BZMA)
Cyclohexyl methacrylate (CHMA)
Diethylene glycol dimethacrylate (DEGDMA)
2-ethyl hexyl methacrylate (EHMA)
Glycidyl methacrylate (GMA)
1,6-hexanediol dimethacrylate (HDDMA)
2-hydroxyethyl methacrylate (2-HEMA)
Isobornyl methacrylate (IBMA)
Lauryl methacrylate (LMA)
Phenoxyethyl methacrylate (PEMA)
t-butyl methacrylate (TBMA)
Tetrahydrofurfuryl methacrylate (THFMA)
Trimethylolpropane trimethacrylate (TMPMA)

Of these materials, in particular, IBOA, TPGDA, HDDA, DPGDA, NPDA and TITA are excellent since the viscosity of these can be set at 10 CP or less.

As the oligomer material, use may be made of, for instance, a urethaneacrylate-based material, polyurethane diacrylate (PUDA), polyurethane hexaacrylate (PUHA), polymethyl methacrylate (PMMA), fluorinated polymethyl methacrylate (PMMA-F), polycarbonate diacrylate, or fluorinated polycarbonate methylmethacrylate (PMMA-PC-F).

As the polymerization initiator, use is made of Irgacure (trademark) 184, Darocure (trademark) 173, etc.

The adhesion layer is a layer for adhering the UV imprint resist and the perpendicular recording film. The adhesion layer should notably be formed of a material which has a resistance to O₂ or O₃ gas and contains, as a main component, Al, Ag, Au, Co, Cr, Cu, Ni, Pd, Pt, Si, Ta, or Ti. The thickness of the adhesion layer should be, notably, 1 to 15 nm.

In the residual removal, the residual of the resist is removed by reactive ion etching (RIE). As a plasma source, an inductively coupled plasma (ICP), which can generate a high-density plasma at low pressure, is suitable. However, an ECR plasma or a general parallel-plate type RIE apparatus may be used.

The protection layer is provided in order to prevent corrosion of the perpendicular magnetic recording layer and to prevent damage to the medium surface when the magnetic head comes in contact with the medium. An example of the material of the protection layer is a material including, for example, C, SiO₂, or ZrO₂. The thickness of the protection layer should be, notably, 1 to 10 nm. This thickness is suitable for high-density recording, since the distance between the head and the medium can be reduced. Carbons can be classified into sp2-bond carbon (graphite) and sp3-bond carbon (diamond). The sp3-bond carbon is superior to graphite with respect to durability and corrosion resistance, but is inferior to graphite with respect to surface smoothness since the sp3-bond carbon is crystalline. Usually, a film of carbon is formed by sputtering, with use of a graphite target. In this method, amorphous carbon, in which sp3-bond carbon and sp3-bond carbon are mixed, is formed. Carbon, in which the ratio of sp3-bond carbon is greater, is called diamond-like carbon (DLC). This carbon has good durability and corrosion resistance and also has good surface smoothness since it is amorphous. Thus, this carbon is used as the surface protection film of the magnetic recording medium.

In the film formation of DLC by a CVD method, a material gas is excited and decomposed in a plasma, and DLC is generated by a chemical reaction. Thus, by matching conditions, DLC which is richer in sp3-bond carbon can be formed. A lubrication layer lay be provided on the protection layer. As a lubricant which is used for the lubrication layer, use may be made of a conventionally publicly known material, such as perfluoropolyether, fluoroalcohol, or fluorinated carboxylic acid.

The C protection film should desirably be formed by CVD in order to improve coverage on asperities, but sputtering or vacuum evaporation may be used. When the C protection film is formed by CVD, a DLC film containing a large quantity of sp3-bond carbon is formed. If the film thickness is 2 nm or less, the coverage undesirably lowers. If the film thickness is 10 nm or more, the magnetic spacing between the recording head and the medium increases and the SNR lowers undesirably.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of manufacturing a magnetic recording medium, comprising:
forming a ferromagnetic film on a substrate;
forming a B thin film on a region for isolating the ferromagnetic film between tracks or bits; and
radiating ions on the B thin film, thereby increasing a B content of the region of the ferromagnetic film, on which the B thin film has been formed, and nonmagnetizing the region.

2. The method of claim 1, nonmagnetizing of the region of the ferromagnetic film, on which the B thin film has been formed, includes diffusing B in the B thin film into the ferromagnetic film by radiating the ions, thereby forming a ferromagnetism-deactivated part having a B content of 15 at % or more in the region of the ferromagnetic film, on which the B thin film has been formed.

3. The method of claim 1, shape of the substrate is discoidal.

4. The method of claim 1, He, Ne or Ar is used as a species of the radiated ions.

5. The method of claim 1, forming of the B thin film includes:
forming a mask material layer on the ferromagnetic film;
forming a resist on the mask material layer;
forming a pattern of a ferromagnetic recording part on the resist by an imprint method using a stamper;
selectively etching the mask material layer by using, as a mask, the resist on which the pattern of the ferromagnetic recording part has been formed; and
forming a B thin film on a surface of the ferromagnetic film, which has been exposed by the selective etching of the mask material layer.

6. The method of claim 5, in order to form the pattern of the ferromagnetic recording part on the resist, light is radiated from a back surface side of the stamper in a state in which a front surface side of the stamper is adhered to the resist, and thereby the resist is cured.

7. The method of claim 5, further comprising removing the mask material layer after nonmagnetizing the region of the ferromagnetic film on which the B thin film has been formed.

8. The method of claim 7, the B thin film is formed at a pressure of 0.5 Pa or more, and less than 1.0 Pa, and the mask material layer is removed by a dry process.

9. The method of claim 7, the B thin film is formed at a pressure of 1.0 Pa or more and 9.0 Pa or less, and the mask material layer is removed by a wet process.

10. The method of claim 1, the substrate comprises a soft magnetic layer being formed on a discoidal substrate, and an underlayer being formed on the soft magnetic layer.

11. The method of claim 10, the discoidal substrate is formed of glass.

12. The method of claim 10, the soft magnetic layer is formed of a material including Fe, Ni or Co, or a Co alloy including Co and at least one selected from among Zr, Hf, Nb, Ta, Ti and Y.

13. The method of claim 10, Ru is used as the underlayer.

14. The method of claim 10, Ti, Ta, W, Cr or Pt, or an alloy including Ti, Ta, W, Cr or Pt, or an oxide or a nitride of Ti, Ta, W, Cr or Pt is used as the underlayer.

15. The method of claim 1, a material including Co and Pt is used as the ferromagnetic film.

16. The method of claim 15, a material further including Cr or an oxide is used as the ferromagnetic film.

17. The method of claim 5, sputtering using a target of B is performed to form the B thin film.

18. The method of claim 8, C is used as the mask material layer.

19. The method of claim 9, a multilayer film in which a C film is formed on a Mo film or a Mg film is used as the mask material layer.

20. The method of claim 6, an ultraviolet-curing resin is used as the resist.
